(19) United States
(12) Patent Application Publication
(10) Pub. No.: US 2024/0283288 A1
(43) Pub. Date: Aug. 22, 2024

(54) SYSTEMS AND METHODS FOR MANAGING POWER CONSUMPTION OF ELECTRONIC DEVICES

(71) Applicant: Helder Feixas, Kearny, NJ (US)

(72) Inventor: Helder Feixas, Kearny, NJ (US)

(21) Appl. No.: 18/581,647

(22) Filed: Feb. 20, 2024

Related U.S. Application Data
(60) Provisional application No. 63/446,880, filed on Feb. 19, 2023.

(51) Int. Cl. H01R 13/66; H01R 13/703

(52) U.S. Cl. CPC H02J 13/0005

(57) ABSTRACT

Systems and methods for managing power consumption of electronic devices are provided. The system may comprise a plurality of smart plugs configured to couple to an endpoint, measure a circuit draw flowing therethrough, and receive one or more signals from a control unit. The system may comprise the control unit. The control unit may comprise a computing device, comprising a processor and a memory configured to store programming instructions that, when executed by the processor, are configured to cause the processor to determine a total circuit draw from the plurality of smart plugs, determine whether multiple smart plugs, of the plurality of smart plugs, are drawing power, and generate and send activation signals and deactivation signals to the multiple smart plugs, causing the multiple smart plugs to selectively alternate between the activated state and the deactivated state, decreasing the total circuit draw to below the maximum circuit load.

### CROSS-REFERENCE TO RELATED APPLICATION

The present application claims priority to U.S. Provisional Patent Application No. 63/446,880, filed Feb. 19, 2023, entitled “Power Multiplexer,” the disclosure of which is incorporated herein by reference in its entirety.

### TECHNICAL FIELD

Embodiments of the present disclosure relate to systems and methods for managing power consumption of electronic devices.

### BACKGROUND

Electronic equipment utilizes electricity to perform its various tasks. These tasks include, but are not limited to, generating light, generating sound, generating heat, performing cooling, performing movement of mechanical components, and/or other suitable tasks. Some of this electric equipment, otherwise known as “loads,” is considered “power-hungry,” meaning that the amount of current it is configured to pull limits the use of multiple appliances from being used simultaneously (e.g., other power-hungry appliances) under a same power source.

When too much current is drawn from an electric circuit, the electric circuit becomes overloaded. This can occur, e.g., when too many appliances are plugged into an electrical outlet, exceeding the current draw limits for the outlet.

Circuit brakers and electric fuses are configured to shut off power to the outlet in the event of too much current being drawn. However, circuit breakers and electric fuses are not impervious to error, particularly in systems with older wiring and switches and systems with improper power distribution, and exceeding the current limit from an electric circuit does run the risk of causing unnecessary stress on wires and electric panels, causing wired to melt, and causing electrical fire.

For at least these reasons, systems and methods for controlling a current flow from multiple appliances in order to prevent a maximum current draw limit from being reached at an electric circuit are needed.

### SUMMARY

According to an object of the present disclosure, a system for managing power consumption of electronic devices is provided. The system may comprise a plurality of smart plugs configured to couple to an endpoint such that each smart plug is configured to transfer electricity from the endpoint to one or more electronic devices, when in an activated state, prevent electricity from transferring from the endpoint to the one or more electronic devices, when in a deactivated state, measure a circuit draw flowing therethrough, and receive one or more signals from a control unit. The system may comprise the control unit. The control unit may comprise a computing device, comprising a processor and a memory, and a transceiver, configured to send one or more signals to the plurality of smart plugs. The endpoint may have a maximum circuit load. The memory may be configured to store programming instructions that, when executed by the processor, are configured to cause the processor to determine a total circuit draw from the plurality of smart plugs, when the total circuit draw is greater than the maximum circuit load, determine whether multiple smart plugs, of the plurality of smart plugs, are drawing power, and, when multiple smart plugs are drawing power, generate and send activation signals and deactivation signals to the multiple smart plugs, causing the multiple smart plugs to selectively alternate between the activated state and the deactivated state, decreasing the total circuit draw to below the maximum circuit load.

According to an exemplary embodiment, the system may comprise a synchronization mechanism. The synchronization mechanism may be configured to cause, as the multiple smart plugs are switched between the activated state and the deactivated state, only one smart plug is in an activated state at a given time, preventing simultaneous activation of multiple smart plugs.

According to an exemplary embodiment, the programming instructions, when executed by the processor, may be further configured to cause the processor to determine whether the total circuit draw is greater than the maximum circuit load.

According to an exemplary embodiment, the programming instructions, when executed by the processor, may be further configured to cause the processor to generate and send an activation signal to each of the plurality of smart plugs, causing each of the plurality of smart plugs to be in the activated state, and, when the total circuit draw is not greater than the maximum circuit load, maintain the activated state of the plurality of smart plugs.

According to an exemplary embodiment, the programming instructions, when executed by the processor, may be further configured to cause the processor to, when multiple smart plugs are not drawing power, determine which smart plug, of the plurality of smart plugs, is drawing power.

According to an exemplary embodiment, the programming instructions, when executed by the processor, may be further configured to cause the processor to generate and send a deactivation signal to the smart plug drawing power, causing the smart plug drawing power to be in the deactivated state.

According to an exemplary embodiment, the generating and sending the activation signals and deactivation signals to the multiple smart plugs may cause the multiple smart plugs to selectively alternate between the activated state and the deactivated state in a fraction of a second.

According to an exemplary embodiment, each of the plurality of smart plugs may comprise an outlet configured to enable the electronic device to plug into the outlet.

According to an exemplary embodiment, the plurality of smart plugs may be configured to communicate wirelessly with the control unit.

According to an exemplary embodiment, the programming instructions, when executed by the processor, may be further configured to cause the processor to determine the maximum circuit load.

According to an object of the present disclosure, a method for managing power consumption of electronic devices is provided. The method may comprise determining a total circuit draw from a plurality of smart plugs. The plurality of smart plugs may be configured to couple to an endpoint such that each smart plug is configured to transfer electricity from the endpoint to one or more electronic devices, when in an activated state, prevent electricity from transferring from the endpoint to the one or more electronic devices, when in a deactivated state, measure a circuit draw flowing therethrough, and receive one or more signals from a control unit, comprising a processor and a memory. The endpoint may have a maximum circuit load. The method may comprise, using the control unit, when the total circuit draw is greater than the maximum circuit load, determining, using the control unit, whether multiple smart plugs, of the plurality of smart plugs, are drawing power, and, when multiple smart plugs are drawing power, generating and sending activation signals and deactivation signals to the multiple smart plugs, causing the multiple smart plugs to selectively alternate between the activated state and the deactivated state, decreasing the total circuit draw to below the maximum circuit load.

According to an exemplary embodiment, the method may comprise, using a synchronization mechanism, as the multiple smart plugs are switched between the activated state and the deactivated state, causing only one smart plug is in an activated state at a given time, preventing simultaneous activation of multiple smart plugs.

According to an exemplary embodiment, the method may comprise, using the control unit, determining whether the total circuit draw is greater than the maximum circuit load.

According to an exemplary embodiment, the method may comprise, using the control unit, generating and sending an activation signal to each of the plurality of smart plugs, causing each of the plurality of smart plugs to be in the activated state, and, when the total circuit draw is not greater than the maximum circuit load, maintaining the activated state of the plurality of smart plugs.

According to an exemplary embodiment, the method may comprise, using the control unit, when multiple smart plugs are not drawing power, determining which smart plug, of the plurality of smart plugs, is drawing power.

According to an exemplary embodiment, the method may comprise, using the control unit, generating and sending a deactivation signal to the smart plug drawing power, causing the smart plug drawing power to be in the deactivated state.

According to an exemplary embodiment, the generating and sending the activation signals and deactivation signals to the multiple smart plugs may cause the multiple smart plugs to selectively alternate between the activated state and the deactivated state in a fraction of a second.

According to an exemplary embodiment, each of the plurality of smart plugs may comprise an outlet configured to enable the electronic device to plug into the outlet.

According to an exemplary embodiment, the plurality of smart plugs may be configured to communicate wirelessly with the control unit.

According to an exemplary embodiment, the method may comprise, using the control unit, determining the maximum circuit load.

Further objectives and advantages of the present disclosure will be apparent from the following detailed description of presently preferred embodiment, which is illustrated schematically in the accompanying drawings.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates an example electrical schematic representation of a system for managing power consumption of electronic devices, according to an exemplary embodiment of the present disclosure.

FIG. 2 illustrates a flow chart of a method for managing power consumption of electronic devices, according to an exemplary embodiment of the present disclosure.

FIG. 3 illustrates example elements of a computing device, according to an exemplary embodiment of the present disclosure.

### DETAILED DESCRIPTION

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

An “electronic device” or a “computing device” refers to a device that comprises a processor and memory. Each device may have its own processor and/or memory, or the processor and/or memory may be shared with other devices as in a virtual machine or container arrangement. The memory may contain or receive programming instructions that, when executed by the processor, cause the electronic device to perform one or more operations according to the programming instructions.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the terms “about” and “approximately” are understood as within a range of normal tolerance in the art, for example within 2 standard deviations of the mean. “About” and “approximately” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the terms “about” and “approximately”.

Hereinafter, embodiments disclosed in this specification will be described in detail with reference to the accompanying drawings, and the same or similar elements will be given the same reference symbols regardless of drawing numbers, and redundant description thereof will be omitted. In addition, a detailed description of well-known features or functions will be ruled out in order not to unnecessarily obscure the gist of the present disclosure.

The illustrative examples described in the detailed description, drawings, and claims are not meant to be limiting. Other examples can be utilized and other changes can be made without departing from the spirit or scope of the subject matter presented herein. It will be readily understood that the aspects of the present disclosure, as generally described herein and illustrated in the figures, can be arranged, substituted, combined, separated, and designed in a wide variety of different configurations, all of which are implicitly contemplated herein.

In the following description, the terms “module” and “unit” for referring to elements are assigned and used interchangeably in consideration of convenience of explanation, and thus, the terms per se do not necessarily have different meanings or functions. Further, in describing the embodiments disclosed in the present specification, when it is determined that a detailed description of a related publicly known technology may obscure the gist of the embodiments disclosed in the present specification, the detailed description thereof will be omitted. In addition, the accompanying drawings are used to help easily understand the embodiments disclosed in this specification, the technical idea disclosed in this specification is not limited by the accompanying drawings, and it should be understood that all alterations, equivalents, and substitutes included in the spirit and scope of the present disclosure are included herein.

Although terms including ordinal numbers, that is, “first”, “second”, etc. may be used herein to describe various elements, the elements are not limited by these terms. These terms are generally only used to distinguish one element from another.

When an element is referred to as being “coupled” or “connected” to another element, the element may be directly coupled or connected to the other element. However, it should be understood that another element may be present therebetween. In contrast, when an element is referred to as being “directly coupled” or “directly connected” to another element, it should be understood that there are no other elements therebetween.

A singular expression includes the plural form unless the context clearly dictates otherwise.

In the present specification, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

The present disclosure generally describes systems and methods for managing power consumption of electronic devices. The present systems and methods may be incorporated into buildings (e.g., houses, apartments, businesses, warehouses, factories, offices, etc.), vehicles (e.g., automobiles, motorcycles, buses, trucks, aircraft, boats, etc.), and/or other suitable usage locations configured to enable a user to make use of AC and/or DC current flow.

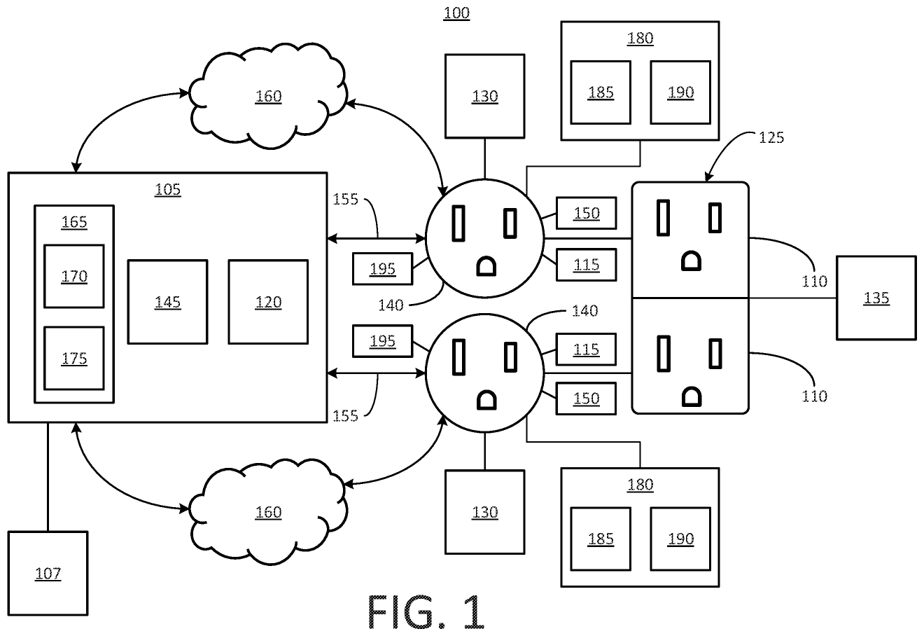

Referring now to FIG. 1, an example electrical schematic representation of a system 100 for managing power consumption of electronic devices is illustratively depicted, in accordance with an exemplary embodiment of the present disclosure.

According to an exemplary embodiment, the system 100 may comprise a control unit 105, a plurality of endpoints 110, and/or a synchronization mechanism 120. The control unit 105 may be configured to manage which endpoints, of the plurality of endpoints 110, are to be opened.

According to an exemplary embodiment, each endpoint 110 may comprise a connection point (e.g., a socket in an electrical outlet 125) through which an electronic device 130 (e.g., an appliance and/or other suitable electronic device) may receive power. According to an exemplary embodiment, each endpoint 110 may be configured to receive power from a power source 135. According to an exemplary embodiment, the number of endpoints 110 in the plurality of endpoints 110 may comprise two or more endpoints 110. It is noted that the number of endpoints 110 in the plurality of endpoints 110 may be configured such as to conform to the expected power consumption of the system 100. According to an exemplary embodiment, the control unit 105 may comprise a power source 107 configured to power the control unit 105. According to an exemplary embodiment, the power source 107 may comprise one or more batteries and/or a connection to an exterior power source (e.g., a connection to a power outlet).

According to an exemplary embodiment, the system 100 may comprise a plurality of smart power plugs 140. According to an exemplary embodiment, each smart power plug 140 may be connected to an endpoint 110 of the plurality of endpoints 110. According to an exemplary embodiment, each smart power plug 140 may be configured such that an electronic device 130 may be plugged into the smart power plug 140. For example, each smart plug 140 may comprise a 2-prong outlet, 3-prong outlet (as shown, e.g., in FIG. 1), and/or other suitable outlet configured to enable the electronic device 130 to plug into the smart plug 140.

According to an exemplary embodiment, each smart power plug 140 may be configured to selectively enable current to flow from an endpoint 110 through the smart power plug 140 to the electronic device 130 while in an activated state. According to an exemplary embodiment, each smart power plug 140 may be configured to disable current from flowing from an endpoint 110 through the smart power plug 140 to the electronic device 130 while in a deactivated state.

According to an exemplary embodiment, each smart plug 140 may comprise a switching mechanism 115. The switching mechanism 115 may comprise a fast-switching mechanism configured to enable the smart plug 140 to rapidly transition between an activated state and a deactivated state. According to an exemplary embodiment, the switching mechanism 115 may be configured to enable each smart plug 140 to transition between an activated state and a deactivated state in a fraction of a second. The switching mechanism 115 may be coupled to the smart plug 140 and/or a component of the smart plug 140.

According to an exemplary embodiment, the synchronization mechanism 120 may be configured to cause and/or ensure that only one smart plug 140 is in an activated state at a given time, preventing simultaneous activation of multiple smart plugs 140.

According to an exemplary embodiment, the control unit 105 may comprise a transceiver 145 configured to send and/or receive signals from each of the plurality of smart plugs 140. According to an exemplary embodiment, each smart plug 140 may comprise a transceiver 150 configured to send and/or receive signals from the control unit 105. The control unit 105 may be configured to communication with each of the plurality of smart plugs 140 via wired connection 155 and/or wireless connection (e.g., through the cloud 160 and/or other suitable means).

The control unit 105 may comprise a computing device 165 comprising a processor 170 and/or a memory 175. According to an exemplary embodiment, the memory 175 may be configured to store programming instructions that, when executed by the processor 170, are configured to cause the processor 170 to perform one or more tasks such as, e.g. reading and/or analyzing one or more signals received from one or more of the plurality of smart plugs 140, determining a maximum circuit load (amps) of an endpoint 110, determining a circuit draw from each smart plug 140 plugged into the endpoint 110, determining whether there is a circuit draw from a plurality of smart plugs 140 plugged into the endpoint 110, determining a total circuit draw from all smart plugs 140 plugged into the endpoint 110, determining whether the total circuit draw from all smart plugs 140 plugged into the endpoint 110, generating one or more signals to activate a smart plug 140 (i.e., enabling the smart plug 140 allow current to flow from an endpoint 110 through the smart power plug 140 to the electronic device 130), deactivating a smart plug 140 (i.e., disabling the smart plug 140, preventing current from flowing from an endpoint 110 through the smart power plug 140 to the electronic device 130), generating one or more signals to selectively alternate one or more smart plugs 140 between an activated state and a deactivated state when the total circuit draw exceeds the maximum circuit load of the endpoint 110, and/or other suitable functions.

According to an exemplary embodiment, the control unit 105 may be configured to generate a signal to selectively activate and/or deactivate smart plugs 140 in a predetermined sequence. According to an exemplary embodiment, the predetermined sequence may comprise switching the plurality of smart plugs 140 between an activated state and a deactivated state at a high frequency rate of change. According to an exemplary embodiment, the computing device 165 may be configured to enable the control unit 105 to generate one or more signals automatically and absent user input. According to an exemplary embodiment, the computing device 165 may be configured to enable the control unit 105 to generate one or more signals in response to user input.

According to an exemplary embodiment, the control unit 105 may be configured to generate a signal to activate only one smart plug 140 at a time and to never enable two or more smart plugs 140 to simultaneously be in an activated state, preventing a large amount of electricity from being pulled from the power source 135 at a single time, when multiple electric devices 130 are coupled to the smart plugs 140, and enabling multiple electronic devices 30 to receive power in a manner that would enable the multiple electronic devices 130 to function simultaneously while not exceeding an electric current limit of the one or more endpoints 110 and/or the power source 135. By preventing a large amount of electricity from being pulled from the power source 135 at a single time when multiple electric devices 130 are coupled to the smart plugs 140, the system aids in protecting houses, cars, and/or other environments or entities from circuit overloads where electricity is used, thereby protecting electrical panels and/or electrical distribution systems from overheating and/or tripping by controlling the amount of electricity used at the same time on that environment or entity. Furthermore, since the system 100 manages power consumption by alternating the endpoints at a high rate of frequency, there is a substantial decrease in electricity usage from the power source 135 of the environment or entity, resulting in a decrease in energy costs.

According to an exemplary embodiment, the system 100 may be configured such that each electrical device 130 accessing power via the plurality of endpoints 110 may be served with a necessary amount of electricity in order to perform its proper needs. According to an exemplary embodiment, each of the one or more smart plugs 140 may be activated and deactivated at a rate/pace defined by the control unit 105.

According to an exemplary embodiment, each of the plurality of smart plugs 140 may comprise a computing device 180 comprising a processor 185 and/or a memory 190. According to an exemplary embodiment, each of the plurality of smart plugs 140 may comprise a sensor 195 configured to sense current in order to determine when current is being drawn (a circuit draw) from an endpoint 110 coupled to the smart plug 140.

According to an exemplary embodiment, the memory 190 may be configured to store programming instructions that, when executed by the processor 185, are configured to cause the processor 185 to perform one or more tasks such as, e.g. reading and/or analyzing one or more signals received from the control unit 105, switching, using the switching mechanism 115 the smart plug 140 into an activated state based on the one or more signals received from the control unit 105, switching, using the switching mechanism 115, the smart plug 140 into a deactivated state based on the one or more signals received from the control unit 105, determining when current is being drawn from the endpoint 110 coupled to the smart plug 140, generating one or more signals to notify the control unit 105 that current is being drawn from an endpoint 110 coupled to the smart plug 140, and/or other suitable functions.

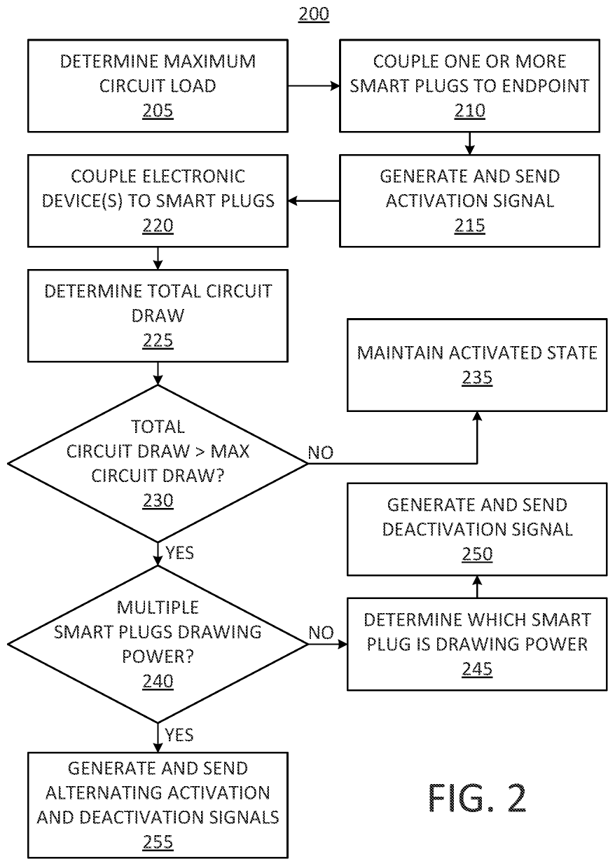

Referring now to FIG. 2, a method 200 for managing power consumption of electronic devices is illustratively depicted, in accordance with an exemplary embodiment of the present disclosure.

At 205, a maximum circuit load (amps) of an endpoint is determined. According to an exemplary embodiment, the maximum circuit load may be determined using the control unit, the one or more smart plugs, and/or other suitable means.

At 210, one or more smart plugs may be coupled to/plugged into the endpoint such that the one or more smart plugs are configured to transfer electricity from the endpoint to one or more electronic devices plugged into the one or more smart plugs. At 215, an activation signal may be generated, by the control unit, and sent to the one or more smart plugs plugged into the endpoint. The activation signal may be configured to cause each of the smart plugs to be in an activated state wherein power may flow from the endpoint through the one or more smart plugs.

At 220, one or more electronic devices (e.g., appliances and/or other suitable electronic devices) may be coupled to/plugged into the one or more smart plugs. At 225, a total circuit draw may be determined from all smart plugs plugged into the endpoint. According to an exemplary embodiment, determining the total circuit draw may comprise determining, via each of the smart plugs, a circuit draw through the smart plug.

At 230, the control unit may determine whether the total circuit draw is greater than the maximum circuit load of the endpoint.

When the total circuit draw is not greater than the maximum circuit load, then, at 235, the activated state of the smart plugs is maintained.

When the total circuit draw is greater than the maximum circuit load, then, at 240, it is determined whether multiple smart plugs are drawing power.

When multiple smart plugs are not drawing power (i.e., a single smart plug is drawing power), then, at 245, it is determined which smart plug is drawing power and, at 250, a deactivation signal may be generated, by the control unit, and sent to the smart plug drawing power. The deactivation signal may be configured to cause the smart plug drawing power to be in a deactivated state wherein power is prevented from flowing from the endpoint through the smart plug.

When multiple plugs are drawing power, then, at 255, the control unit, implementing a switching mechanism, may generate and send activation signals and deactivation signals to the multiple smart plugs, causing the multiple smart plugs to selectively alternate between an activated state and a deactivated state, decreasing the total circuit draw to below the maximum circuit load. According to an exemplary embodiment, as the multiple smart plugs are switched between the activated state and the deactivated state, a synchronization mechanism may be used to cause only one smart plug to be in an activated state at a given time, preventing simultaneous activation of multiple smart plugs. According to an exemplary embodiment, the switching mechanism may be configured to enable each smart plug to transition between an activated state and a deactivated state in a fraction of a second. It is noted, however, that other time periods between the activated and deactivated state may be incorporated while maintaining the spirit and functionality of the present disclosure.

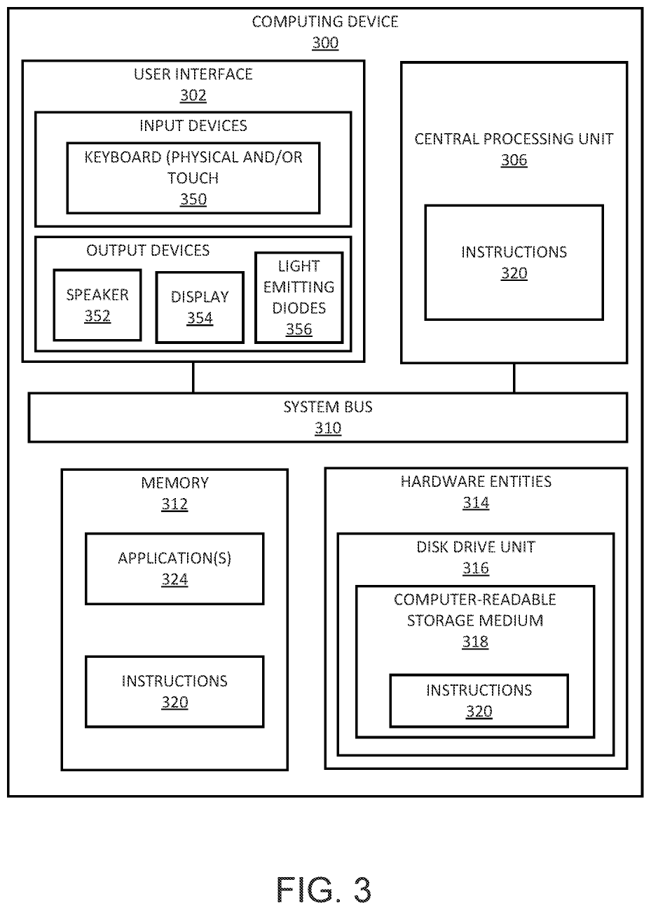

Referring now to FIG. 3, an illustration of an example architecture for a computing device 300 is provided. According to an exemplary embodiment, one or more functions of the present disclosure may be implemented by a computing device such as, e.g., computing device 300 or a computing device similar to computing device 300. Computing device 300 may be a quantum computer, a classical computer, and/or have one or more components configured to perform one or more quantum and/or classical computing functions. Computing device 165 and/or computing device 180 may be an example of computing device 300 and/or may comprise one or more components of computing device 300.

The hardware architecture of FIG. 3 represents one example implementation of a representative computing device configured to implement at least a portion of the systems/devices (e.g., system 100) and method(s)/control logic(s) (e.g., method 200) described herein.

Some or all components of the computing device 300 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 3, the computing device 300 may comprise a user interface 302 (e.g., a graphical user interface), a Central Processing Unit (“CPU”) 306, a system bus 310, a memory 312 connected to and accessible by other portions of computing device 300 through system bus 310, and hardware entities 314 connected to system bus 310. The user interface may comprise input devices and output devices, which may be configured to facilitate user-software interactions for controlling operations of the computing device 300. The input devices may comprise, but are not limited to, a physical and/or touch keyboard 340. The input devices may be connected to the computing device 300 via a wired or wireless connection (e.g., a Bluetooth® connection). The output devices may comprise, but are not limited to, a speaker 342, a display 344, and/or light emitting diodes 346.

At least some of the hardware entities 314 may be configured to perform actions involving access to and use of memory 312, which may be a Random Access Memory (RAM), a disk driver and/or a Compact Disc Read Only Memory (CD-ROM), among other suitable memory types. Hardware entities 314 may comprise a disk drive unit 316 comprising a computer-readable storage medium 318 on which may be stored one or more sets of instructions 320 (e.g., programming instructions such as, but not limited to, software code) configured to implement one or more of the methodologies, procedures, or functions described herein. The instructions 320 may also reside, completely or at least partially, within the memory 312 and/or within the CPU 306 during execution thereof by the computing device 300.

The memory 312 and the CPU 306 may also constitute machine-readable media. The term “machine-readable media”, as used here, refers to a single medium or multiple media (e.g., a centralized or distributed database, and/or associated caches and servers) that store the one or more sets of instructions 320. The term “machine-readable media”, as used here, also refers to any medium that is capable of storing, encoding, or carrying a set of instructions 320 for execution by the computing device 300 and that cause the computing device 300 to perform any one or more of the methodologies of the present disclosure.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present disclosure and its particular application and to thereby enable those skilled in the art to make and use embodiments of the disclosure. However, those skilled in the art will recognize that the foregoing description and examples have been presented for the purposes of illustration and example only. The description as set forth is not intended to be exhaustive or to limit the embodiments of the disclosure to the precise form disclosed.

What is claimed is:

1. A system for managing power consumption of electronic devices, comprising:
a plurality of smart plugs configured to couple to an endpoint such that each smart plug is configured to:
transfer electricity from the endpoint to one or more electronic devices, when in an activated state;
prevent electricity from transferring from the endpoint to the one or more electronic devices, when in a deactivated state;
measure a circuit draw flowing therethrough; and
receive one or more signals from a control unit; and
the control unit, comprising:
a computing device, comprising a processor and a memory; and
a transceiver, configured to send one or more signals to the plurality of smart plugs,
wherein:
the endpoint has a maximum circuit load, and
the memory is configured to store programming instructions that, when executed by the processor, are configured to cause the processor to:
determine a total circuit draw from the plurality of smart plugs;
when the total circuit draw is greater than the maximum circuit load, determine whether multiple smart plugs, of the plurality of smart plugs, are drawing power; and
when multiple smart plugs are drawing power, generate and send activation signals and deactivation signals to the multiple smart plugs, causing the multiple smart plugs to selectively alternate between the activated state and the deactivated state, decreasing the total circuit draw to below the maximum circuit load.

2. The system of claim 1, further comprising a synchronization mechanism,
wherein the synchronization mechanism is configured to cause, as the multiple smart plugs are switched between the activated state and the deactivated state, only one smart plug is in an activated state at a given time, preventing simultaneous activation of multiple smart plugs.

3. The system of claim 1, wherein the programming instructions, when executed by the processor, are further configured to cause the processor to determine whether the total circuit draw is greater than the maximum circuit load.

4. The system of claim 3, wherein the programming instructions, when executed by the processor, are further configured to cause the processor to:
generate and send an activation signal to each of the plurality of smart plugs, causing each of the plurality of smart plugs to be in the activated state; and
when the total circuit draw is not greater than the maximum circuit load, maintain the activated state of the plurality of smart plugs.

5. The system of claim 1, wherein the programming instructions, when executed by the processor, are further configured to cause the processor to:
when multiple smart plugs are not drawing power, determine which smart plug, of the plurality of smart plugs, is drawing power.

6. The system of claim 5, wherein the programming instructions, when executed by the processor, are further configured to cause the processor to generate and send a deactivation signal to the smart plug drawing power, causing the smart plug drawing power to be in the deactivated state.

7. The system of claim 1, wherein the generating and sending the activation signals and deactivation signals to the multiple smart plugs causes the multiple smart plugs to selectively alternate between the activated state and the deactivated state in a fraction of a second.

8. The system of claim 1, wherein each of the plurality of smart plugs comprises an outlet configured to enable the electronic device to plug into the outlet.

9. The system of claim 1, wherein the plurality of smart plugs are configured to communicate wirelessly with the control unit.

10. The system of claim 1, wherein the programming instructions, when executed by the processor, are further configured to cause the processor to determine the maximum circuit load.

11. A method for managing power consumption of electronic devices, comprising:
determining a total circuit draw from a plurality of smart plugs,
wherein:
the plurality of smart plugs configured to couple to an endpoint such that each smart plug is configured to:
transfer electricity from the endpoint to one or more electronic devices, when in an activated state;
prevent electricity from transferring from the endpoint to the one or more electronic devices, when in a deactivated state;
measure a circuit draw flowing therethrough; and
receive one or more signals from a control unit, comprising a processor and a memory; and
the endpoint has a maximum circuit load; and
using the control unit:
when the total circuit draw is greater than the maximum circuit load, determining, using the control unit, whether multiple smart plugs, of the plurality of smart plugs, are drawing power; and
when multiple smart plugs are drawing power, generating and sending activation signals and deactivation signals to the multiple smart plugs, causing the multiple smart plugs to selectively alternate between the activated state and the deactivated state, decreasing the total circuit draw to below the maximum circuit load.

12. The method of claim 11, further comprising, using a synchronization mechanism, as the multiple smart plugs are switched between the activated state and the deactivated state, causing only one smart plug is in an activated state at a given time, preventing simultaneous activation of multiple smart plugs.

13. The method of claim 11, further comprising, using the control unit, determining whether the total circuit draw is greater than the maximum circuit load.

14. The method of claim 13, further comprising, using the control unit:
generating and sending an activation signal to each of the plurality of smart plugs, causing each of the plurality of smart plugs to be in the activated state; and
when the total circuit draw is not greater than the maximum circuit load, maintaining the activated state of the plurality of smart plugs.

15. The method of claim 11, further comprising, using the control unit, when multiple smart plugs are not drawing power, determining which smart plug, of the plurality of smart plugs, is drawing power.

16. The method of claim 15, further comprising, using the control unit, generating and sending a deactivation signal to the smart plug drawing power, causing the smart plug drawing power to be in the deactivated state.

17. The method of claim 11, wherein the generating and sending the activation signals and deactivation signals to the multiple smart plugs causes the multiple smart plugs to selectively alternate between the activated state and the deactivated state in a fraction of a second.

18. The method of claim 11, wherein each of the plurality of smart plugs comprises an outlet configured to enable the electronic device to plug into the outlet.

19. The method of claim 11, wherein the plurality of smart plugs are configured to communicate wirelessly with the control unit.

20. The method of claim 11, further comprising, using the control unit, determining the maximum circuit load.
